(19) United States
(12) Patent Application Publication
(10) Pub. No.: US 2017/0198854 A1
(43) Pub. Date: Jul. 13, 2017

(54) WATER PIPE DRONE FOR DETECTING AND FIXING LEAKS

(71) Applicant: AMERICAN WATER WORKS COMPANY, INC., Voorhees, NJ (US)

(72) Inventor: PAUL GAGLIARDO, ENCINITAS, CA (US)

(21) Appl. No.: 15/472,013

(22) Filed: Mar. 28, 2017

Related U.S. Application Data
(63) Continuation of application No. 15/009,407, filed on Jan. 28, 2016.
(60) Provisional application No. 62/110,170, filed on Jan. 30, 2015.

(51) Int. Cl. F16L 55/1645; F16L 55/32

(52) U.S. Cl. CPC F16L 55/1645; F16L 55/32; B05C 7/08

(57) ABSTRACT

An apparatus for detecting and repairing leaks in buried pipes is described. The apparatus includes a control device and a pipe drone, the pipe drone comprising a housing, a leak detection component, a pipe repairing component, a propulsion device, and a communication component. The pipe drone and the control device may be separate but can be communicatively coupled either wirelessly or by a tether so that the control device can power and/or control the pipe drone, the pipe drone configured to detect and repair leaks in a pipe through which the drone is traveling. The pipe drone may be operated manually or be configured via the control device to operate autonomously to detect and fix leaks within the pipe.

### CROSS-REFERENCE TO RELATED APPLICATIONS

This application is a continuation application claiming priority to co-pending U.S. patent application Ser. No. 15/009,407, filed Jan. 28, 2016, titled “Water Pipe Drone for Detecting and Fixing Leaks,” which claims priority to U.S. Provisional Patent Application No. 62/110,170, filed Jan. 30, 2015, titled “Water Pipe Drone for Detecting and Fixing Leaks.” The contents of these referenced applications are incorporated herein by reference in their entirety.

### BACKGROUND

Water distribution in municipalities is frequently accomplished using buried pipes that run from central distribution facilities to individual service locations through a large and complex network of piping. Buried water pipes allow a stable and hidden water distribution infrastructure, but after installation, buried pipes are very difficult to access for service. As a result, repairs and modifications to buried water pipes after installation are complex, time consuming, and expensive due to the labor intensive procedures involved in excavating and accessing the pipes. As a result, a new method of detecting and repairing leaks in buried water pipes is needed.

### SUMMARY

Embodiments of the present technology are defined by the claims below, not this summary. This summary merely presents a high-level overview of various aspects of the technology and a selection of concepts that are further described below in the detailed description section of this disclosure. This summary is not intended to identify key or essential features of the claimed subject matter, nor is it intended to be used as an aid in isolation to determine the scope of the claimed subject matter. The scope of the invention is defined by the claims.

In a first embodiment, a device for detecting and repairing leaks inside pipes is provided, in accordance with an embodiment of the present technology. The device comprises a control device and a pipe drone, the pipe drone comprising a housing, a propulsion device coupled to the housing for moving the pipe drone through a pipe filled with fluid, a leak detector coupled to the housing for detecting a leak in the pipe, a pipe repairing component coupled to the housing for repairing a wall of the pipe, and a communication component coupled to the housing and configured to communicate with the control device. The pipe drone and the control device may be separate.

In a second embodiment, a method of detecting and repairing leaks inside pipes is provided, in accordance with an embodiment of the present technology. The method comprises providing a control device and a pipe drone, the pipe drone comprising a housing, a propulsion device coupled to the housing for moving the housing through a pipe filled with fluid, a leak detector coupled to the housing for detecting a leak in the pipe, a pipe repairing component coupled to the housing for repairing a wall of the pipe, and a communication component coupled to the housing and configured to communicate with the control device. The pipe drone and the control device may be separate. The method further comprises inserting the pipe drone into the pipe until the pipe drone is submerged in fluid, and controlling the pipe drone using the control device to navigate the drone through one or more pipes. The drone may be propelled by the propulsion device. The method further comprises using the leak detector to locate one or more leaks within the pipe, and using the pipe repairing component to at least partially repair the one or more leaks.

In a third embodiment, a method of manufacturing a device for detecting and repairing leaks inside pipes is provided, in accordance with an embodiment of the present technology. The method comprises providing a control device and a pipe drone, the pipe drone comprising a housing, a leak detector, a pipe repairing component, a propulsion device, and a communication component. The method further comprises coupling the propulsion device to the housing, the propulsion device capable of moving the pipe drone through a pipe filled with fluid. The method further comprises coupling the leak detector to the housing, the leak detector configured to detect a leak in the pipe, and coupling the pipe repairing component to the housing, the pipe repairing component configured to repair a damaged wall of the pipe. Further, the method comprises coupling a communication component to the housing, the communication component configured to communicate with the control device. The control device and the pipe drone may be separate.

### BRIEF DESCRIPTION OF THE SEVERAL VIEWS OF THE DRAWINGS

Embodiments of the present invention are described in detail below with reference to the attached drawing figures, which are exemplary and non-exclusive in nature, wherein:

FIG. 1 depicts a first exemplary embodiment of a pipe drone, in accordance with an embodiment of the present technology;

FIG. 2 depicts an alternate perspective view of the pipe drone shown in FIG. 1, in accordance with an embodiment of the present technology;

FIG. 3 depicts a second exemplary embodiment of a pipe drone, in accordance with an embodiment of the present technology;

FIG. 4 depicts an alternate view of the pipe drone shown in FIG. 3, in accordance with an embodiment of the present technology;

FIG. 5 depicts the pipe drone shown in FIG. 1 with a tether coupled to the pipe drone, in accordance with an embodiment of the present technology;

FIG. 6 depicts an alternate view of the pipe drone shown in FIG. 5, in accordance with an embodiment of the present technology;

FIG. 7 depicts a pipe drone with a drive mechanism configured to propel the pipe drone through a pipe when the pipe drone is not fully submerged in fluid, in accordance with an embodiment of the present technology;

FIG. 8 depicts an exemplary use of the pipe drone shown in FIG. 7 inside a pipe, in accordance with an embodiment of the present technology;

FIG. 9 depicts a pipe drone with multiple bracing components for holding the drone against the inside of a pipe, in accordance with an embodiment of the present technology;

FIG. 10 depicts an exemplary use of the pipe drone shown in FIG. 9 inside of a pipe, in accordance with an embodiment of the present technology;

FIG. 11 depicts an exemplary operation of a pipe drone with a wireless control connection, in accordance with an embodiment of the present technology;

FIG. 12 depicts an exemplary operation of a pipe drone with a tethered control connection, in accordance with an embodiment of the present technology;

FIG. 13 depicts a block diagram of an exemplary method of detecting and repairing leaks inside pipes, in accordance with an embodiment of the present technology; and

FIG. 14 depicts a block diagram of a method of manufacturing a device for detecting and repairing leaks inside pipes, in accordance with an embodiment of the present technology.

### DETAILED DESCRIPTION

The subject matter of the present technology is described with specificity in this disclosure to meet statutory requirements. However, the description is not intended to limit the scope of the claims. Rather, the claimed subject matter may be embodied in various other ways to include different features, components, elements, combinations, and steps, similar to the ones described in this document, and in conjunction with other present and future technologies. Terms should not be interpreted as implying any particular order among or between various steps disclosed herein unless the stated order of steps is explicitly required. Many different arrangements of the various components depicted, as well as use of components not shown, are possible without departing from the scope of the claims.

In one embodiment, a device for detecting and repairing leaks inside pipes is provided, in accordance with an embodiment of the present technology. The device comprises a control device and a pipe drone, the pipe drone comprising a housing, a propulsion device coupled to the housing for moving the pipe drone through a pipe filled with fluid, a leak detector coupled to the housing for detecting a leak in the pipe, a pipe repairing component coupled to the housing for repairing a wall of the pipe, and a communication component coupled to the housing and configured to communicate with a control device separate from the pipe drone.

The control device is provided separately from the pipe drone to allow remote control of the pipe drone when the pipe drone is used to locate and repair leaks within a pipe system. Various arrangements of these components are possible to provide a pipe drone that can fit inside various pipes, move in various ways, and detect and repair leaks using various components or methods. For example, the housing of the pipe drone may be a tubular housing to which various components of the device can be coupled, or at least partially contained within. The tubular housing may be selected to fit into pipes of varying styles, shapes, structures, and/or states of wear and tear. The housing may be shaped to have fluid-dynamic properties, and may be narrowed at one end to streamline propulsion and forward movement through a pipe.

The pipe drone may include a propulsion device to move the drone inside a pipe. The propulsion device may include a motor and propeller at one end of the pipe drone that propels the device in a forward and/or backward direction when submerged in liquid in a pipe. The propulsion device may be powered by the drone itself, or may be powered through a tether to the control device or other powering device. The propulsion device may include a recessed propeller with an electric motor and/or multiple propellers or impellers.

The propulsion device may be battery powered, and may be configured to propel the drone when submerged in liquid, such as when used in a fluid filled pipe, but may also include other propulsion mechanisms, or movement mechanisms, that allow the drone to be propelled in partially fluid filled pipes, or dry pipes. For example, the pipe drone may additionally include wheels or treads coupled to the drone. In partially filled pipes, or dry pipes, the wheels or treads may be engaged to propel the drone through the pipe when the drone ceases being fully suspended in liquid.

Any of the propulsion mechanisms or components may be controlled remotely by a user using the control device. The control device may be configured to send specific instructions for movement, detection of leaks, and repair of leaks to the pipe drone, and the communication component may be configured to receive these instructions. The control device and communication component may also be configured to send and receive commands for automated action by the pipe drone. In this regard, the pipe drone may operate autonomously.

The leak detector may be coupled to the housing and may be wholly or partially contained inside or outside of the pipe drone and/or inside or outside of the housing. The leak detector, which may also be referred to as a pipe inspecting component, may be configured to detect leaks or irregularities in the pipe by analyzing the wall of the pipe. Multiple leak detection components may be incorporated into each drone, of the same or different types, and the leak detection components may be incorporated on various sides of the pipe drone to allow analysis of different areas of the inner pipe wall at the same time as the drone passes through the pipe.

The pipe drone may also include structures or mechanisms configured to allow the drone to rotate or turn within the fluid filled pipe so that the leak detector can view different areas of a single pipe circumference inside the pipe. In one configuration, the housing may be tubular in shape and contain a viewing port through which a leak detection device or component positioned inside the housing may view out of the port to examine the state of the inner pipe wall proximate to the pipe drone. The leak detector may include and utilize a variety of leak detection technologies, including: cameras, sensors, radar, acoustic detection, ultrasound, imaging, or pressure differential detection, as well as any number of other known technologies for detecting pipe leaks.

By locating a pipe leak from inside the pipe, without excavation, a variety of cost effective surface-based repair techniques can also be utilized to repair a leaking pipe, in addition to the repairs conducted by the pipe drone. For example, after a pipe drone detects and/or partially repairs a leak, a thin proboscis device may be inserted into the ground to inject a leak stopping substance or compound, such as an expanding filler, near the pipe leak to assist in stopping the leak. In this regard, simply using the pipe drone to locate the leak in an underground pipe can provide the information needed to more effectively apply a surface or excavation-based repair of the pipe. This may be especially useful if it is determined that the pipe drone cannot fully repair the leak.

The pipe repairing component may also include a variety of mechanisms, tools, or components to facilitate repair of a pipe leak, either partially or wholly. The pipe repairing component may utilize adhesives, solvents, epoxies, glues, polymers, expandable foams or similar substances, as well as a pipe patch or other physical or chemical pipe repairing technology. Additionally, welding, such as hyperbaric welding that can operate in the depth and pressure of a submerged liquid, may also be used by the pipe drone to repair a leak from inside the pipe.

To facilitate the repair of leaks within a pipe, the housing of the pipe drone may include a bracing component which is configured to selectively secure the pipe drone housing to the inner walls of the pipe to allow the pipe drone to remain in a fixed and/or non-rotating position when attempting to fix a pipe leak. In this regard, the pipe drone may also utilize a suction device coupled to the drone to draw water through an opening and create a fluid force that forcibly suctions the drone against a pipe wall or other surface, providing stability. Additionally, after suction bracing, the pipe drone may engage a second drive mechanism, such as treads or wheels, to move around the surface against which the pipe drone is braced. By bracing the pipe drone against the pipe wall, the pipe drone can obtain better leverage for applying materials or techniques to the pipe wall to attempt to fix the leak.

One embodiment of a pipe drone may include a pipe repairing component that is contained partially or wholly outside of the housing of the pipe drone. The portion outside of the housing may be a tube or other application component extending from the front area of the housing of the pipe drone and terminating at a distal end. The distal end may have a nozzle, outlet, or other application component for applying pipe repairing material. In one configuration, when a leak is detected, the pipe repairing component outside of the housing may be controlled so that the distal end is placed near the area where the pipe is damaged, and then subsequently some pipe repairing material such as glue, expandable foam, epoxy, resin, or something similar may be selectively applied to the damaged or leaking part of the pipe through the nozzle.

In another configuration, a mechanical apparatus may be coupled to the housing and at least partially extend from the housing to fix leaks (e.g., a welder). Upon completing the desired pipe repair, the drone may continue onward to detect and repair other damage or leaks. Even in circumstances where a full repair of the damaged pipe is not possible, the drone can serve to prevent or delay the need for excavation, and may allow alternative repair means that do not require excavation of the pipes, such as use of a proboscis, described above. Repairs conducted by the pipe drone may be initiated by instruction from the control device, via the instructions received by the communication component. The repairs carried out by the pipe drone may be controlled manually by a user, or may be automated based on the instructions received.

The communication component and control device may be coupled and interact in a number of ways to facilitate control of the pipe drone. In one configuration, the communication component is positioned within the housing of the pipe drone, and communicatively coupled to the control device, which is outside of the housing and separate from the pipe drone. The communication component and the control device may be tethered, or may communicate wirelessly. The control device, pipe drone, and/or communication component may further comprise a transmitter or receiver.

In another embodiment, a method of detecting and repairing leaks inside pipes is provided. The method comprises providing a pipe fixing device, such as the pipe drone and control device described above, inserting the pipe drone into a pipe until the pipe drone is submerged in fluid, controlling the pipe drone using the control device to navigate the drone through one or more pipes filled with fluid, the pipe drone propelled by the propulsion device, using the leak detector to locate one or more leaks within the pipe, and using the pipe repairing component to at least partially repair the one or more leaks.

The pipe drone may be inserted into a pipe at any number of entry points, such as a fire hydrant, storm sewer, or other surface opening. Once submersed in fluid in the pipe system, the drone may be navigated by a user above ground using the control device, either manually or by sending automated commands to the drone. The drone may follow a preset path, or preset analysis mode for checking a pipe or a section of pipe, based on the needs of the operator or the amount of operative distance from the control device and the range of the drone.

An operator controlling the drone may receive different types of feedback via the control device regarding the drone's location, orientation, positioning in the pipe, state of detection or repair, and/or other visual and system indications related to the state of the drone and the state of the pipe proximate to the drone. For example, the drone may include a camera (e.g., providing still pictures and/or video imaging) and lights for detecting and analyzing the inside surface of a pipe, and this information may be communicated back to an operator.

The operator may control the movement of the drone by providing power to the propulsion device, including power to a propeller when the drone is submerged, or power to wheels or treads when the drone is not submerged. The drone operator may also have a coupling with the drone for extracting the drone from the pipe, such as when the drone becomes unsubmerged near the exit, or when the drone is stuck or wedged in the pipe. The drone operator may be able to control the orientation and function of the repair component, activating a repair mechanism such as a welder or dispersing element, for example, directing the repair component directly into the section of the pipe which is compromised. The drone may also have a “recovery” mode in which the drone returns to the pipe entry point when communication is lost or another error occurs in the function of the drone.

The drone may also include a boring or clearing element oriented in the direction of travel of the drone. Water pipes frequently become corroded or filled with buildup, called tuberculation, which can block the path of water flow, and subsequently, the path of the drone. In this regard, the drone may not work in all situations. However, a boring or clearing component coupled to an end of the drone may provide the drone with sufficient ability to clear the clogged pipe and continue with leak detection and repair.

In another embodiment, a method of manufacturing a device for detecting and repairing leaks inside pipes is provided. The method comprises providing a housing, coupling a propulsion device to the housing, the propulsion device capable of moving the housing through a pipe filled with fluid, coupling a leak detector to the housing, the leak detector configured to detect a leak in the pipe, coupling a pipe repairing component to the housing, the pipe repairing component configured to repair a damaged wall of the pipe, providing a control device separate from the housing, and coupling a communication component to the housing, the communication component configured to communicate with the control device. The control device may be provided separately from the pipe drone, and communicatively coupled to the pipe drone wirelessly or with a cable or tether, such as a fiber-optic communication cable shielded or insulated to protect it from conditions within the pipe, including liquid and pressure.

Further, any number of pipe inspecting or detecting components may be coupled to the drone, including lights, cameras (e.g., for providing still images and/or video output), sensors, pressure detection equipment, acoustic detection equipment, and similar measurement or analysis devices for analyzing the inside of a pipe. The pipe repairing component coupled to the pipe drone may include one or more of the repair components described above, and may be positioned or coupled to any part, inside or outside, or partially inside or outside, of the drone, including the housing. The pipe repairing component may employ commonly known fixing materials for pipes, or apparatuses for the same, such as a spray can of pipe sealer. The repair and detection mechanisms may be configured to be interchangeable to allow variations in use and function of the pipe drone. A pipe securement or bracing component may also be affixed or coupled to the pipe drone to allow temporary or selective securement of the drone to the inside of a pipe. The securement component may include extendable legs or arms, a suction motor to pull the drone against the pipe, a magnetic component, or other similarly functioning mechanisms or devices.

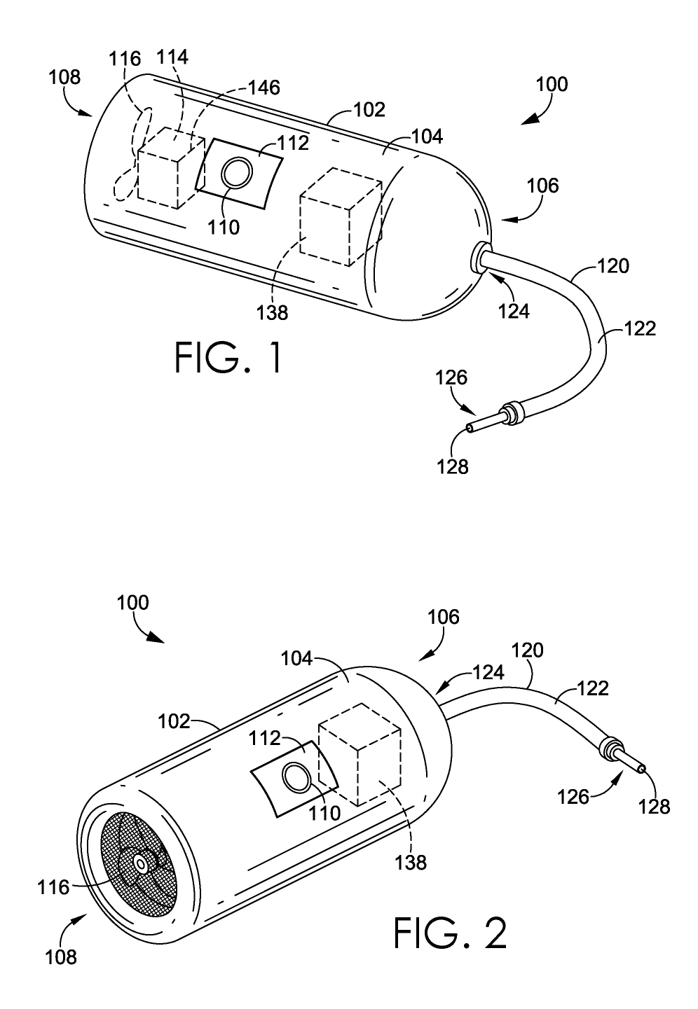

Referring to FIG. 1, a first perspective view of a first exemplary embodiment 100 of a pipe drone 102 is depicted, in accordance with an embodiment of the present technology. In FIG. 1, the pipe drone 102 is configured for inspection and repair of a pipe. The device includes a housing 104 having a first end 106 and a second end 108. Coupled to the housing 104 is a leak detector 110 and a viewport 112 for the leak detector 110. It should be noted that the leak detector 110 or another pipe inspection component may be located inside or outside of the housing 104 in a variety of configurations to have different interactions with the environment outside of the pipe drone 102, based on the type of leak detector 110 that is selected (e.g., infrared, camera, acoustic detection, etc.).

Further coupled to the housing 104 is a propulsion device 114 having a propeller 116. The propeller 116 is located near the second end 108 of the housing 104. A pipe repairing component 120 is coupled to the housing 104 near the first end 106 of the housing 104, the pipe repairing component 120 including an elongated portion 122 having a first end 124 and a second end 126, the second end 126 having a distal end nozzle 128 for applying a substance or compound for repairing an inner wall of a pipe to stop a leak. The pipe drone 102 further comprises an interior drive mechanism 146, which can be a motor or similar device for powering the propulsion device 114, and a communication component 138 that provides communication with a separate control unit.

FIG. 2 depicts an alternate view of the pipe drone 102 shown in FIG. 1, in accordance with an embodiment of the present technology. In FIG. 2, the features shown in FIG. 1 are again depicted, with the propeller 116 clearly shown positioned at the second end 108 of the housing 104.

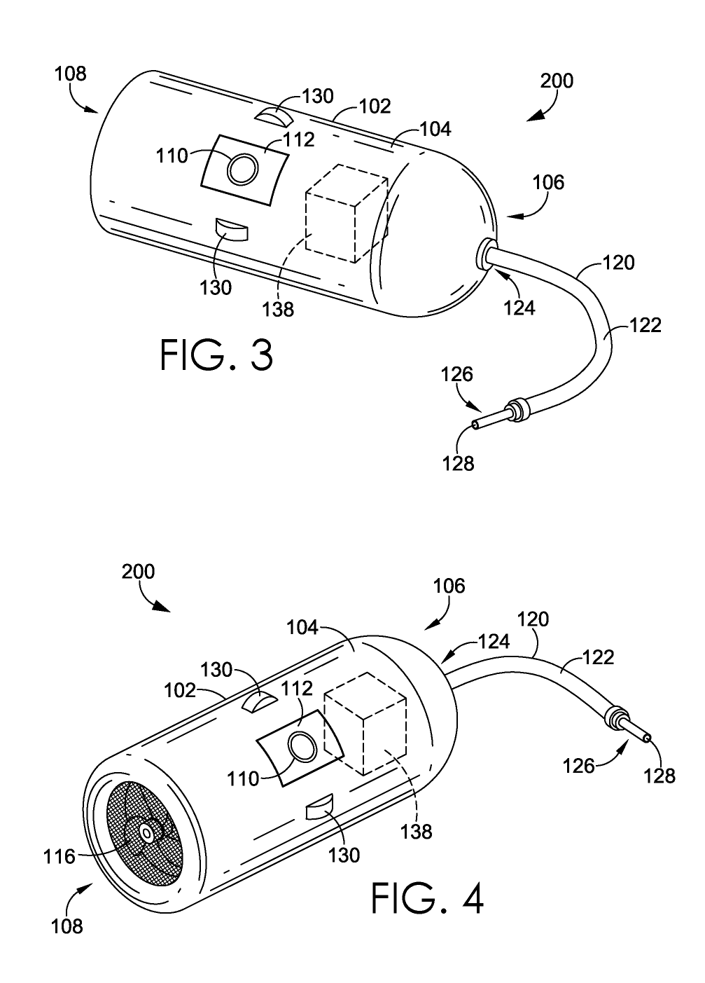

FIG. 3 depicts a second exemplary embodiment 200 of the pipe drone 102, in accordance with an embodiment of the present technology. In FIG. 3, many of the features shown in FIG. 1 are again depicted. The embodiment 200 of the pipe drone 102 shown in FIG. 3 further includes leak detection sensors 130 configured to detect leaks on an inner wall of a pipe through which the pipe drone 102 is traveling. The leak detection sensors 130 may be based on visual, infrared, acoustic, and/or pressure detection methods, or other methods.

FIG. 4 depicts a second perspective view of the second exemplary embodiment 200 of the pipe drone 102 shown in FIG. 3, in accordance with an embodiment of the present technology. In FIG. 4, many of the features shown in FIG. 3 are again depicted on the drone 102, with the propeller 116 more clearly shown at the second end 108 of the drone 102.

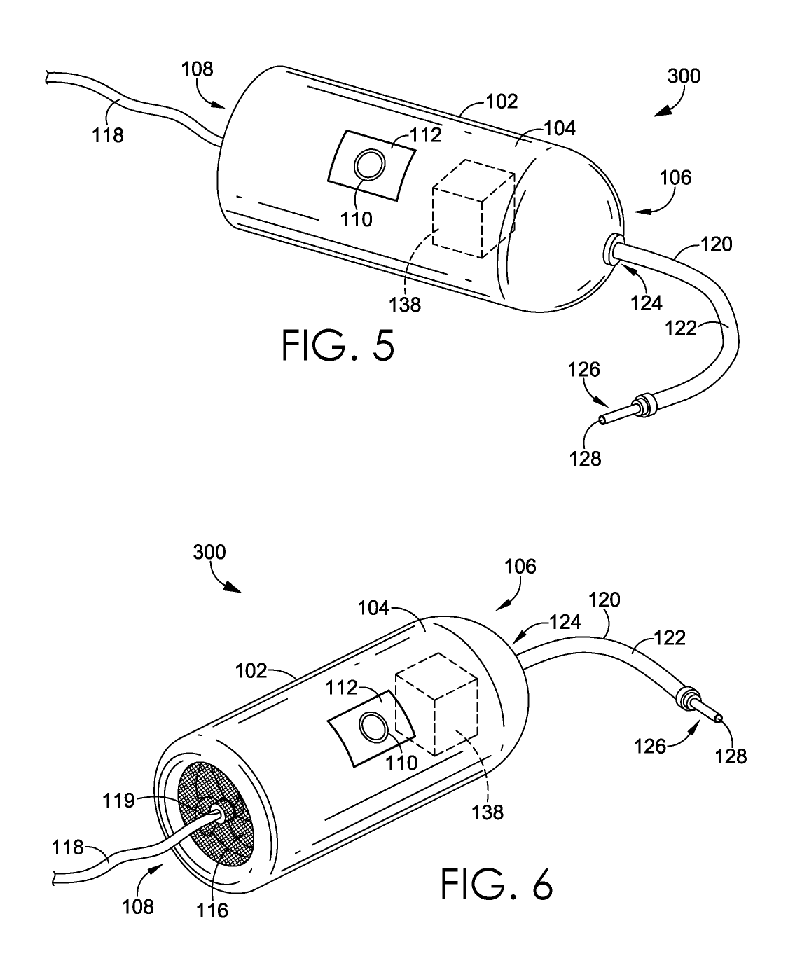

FIG. 5 depicts a third exemplary embodiment 300 of the pipe drone 102 shown in FIG. 1 with a tether 118 coupled to the pipe drone 102, in accordance with an embodiment of the present technology. The tether 118 is shown coupled to the second end 108 of the housing 104. The tether 118 may be coupled to a control device 140 (not shown in FIG. 5).

FIG. 6 depicts an alternate view of the third exemplary embodiment 300 of the pipe drone 102 shown in FIG. 5, in accordance with an embodiment of the present technology. In FIG. 6, the pipe drone 102 includes a propeller 116 at the second end 108 of the housing 104. Additionally, the tether 118 is shown coupled to the second end 108 of the housing 104 at an attachment point 119 at the center of the propeller 116. The attachment point 119 is not limited to the second end 108 of the housing 104, and may be positioned at any location or orientation on the pipe drone 102, as needed.

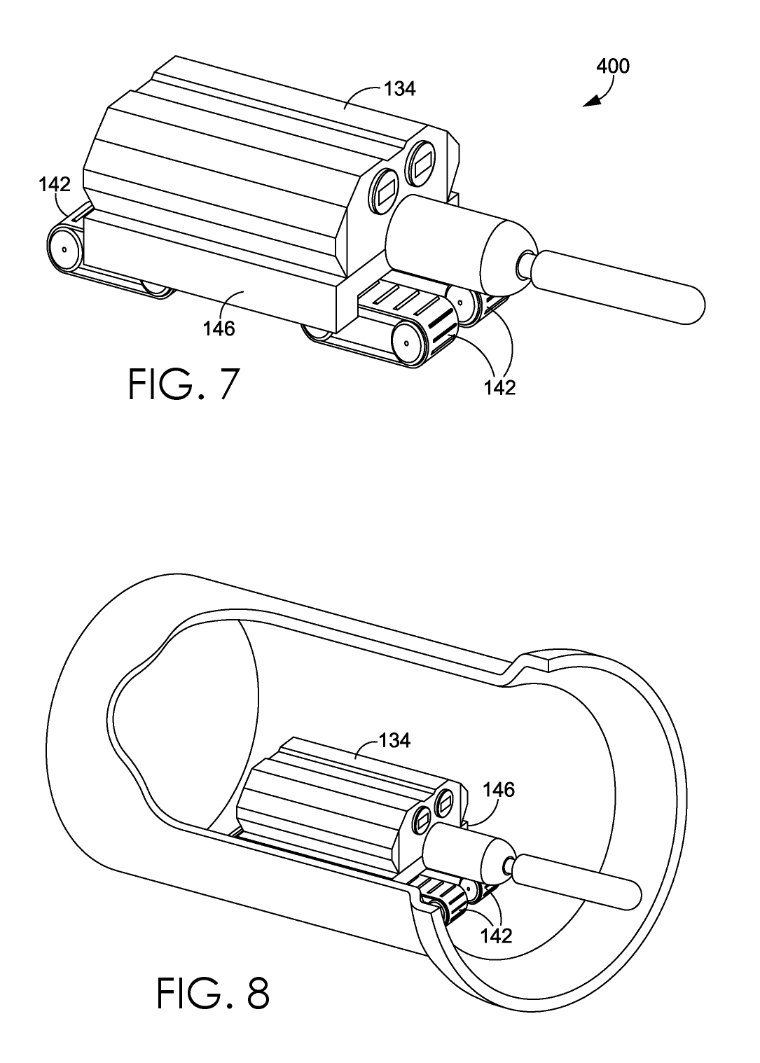

FIG. 7 depicts a pipe drone 400 with a drive mechanism configured to propel the pipe drone 400 through a pipe when the pipe drone 400 is not fully submerged in liquid, in accordance with an embodiment of the present technology. In FIG. 7, the drive mechanism 146 includes a drive motor 134 and treads 142. The treads 142 can be mounted on multiple sides of the pipe drone 400 and/or comprise multiple configurations, depending on the desired level of mobility of the pipe drone 400. FIG. 8 depicts an exemplary use of the pipe drone 400 shown in FIG. 7 inside a pipe, in accordance with an embodiment of the present technology. In FIG. 8, the treads 142 are resting on an inner wall of a pipe to propel the pipe drone 400 forward through the pipe.

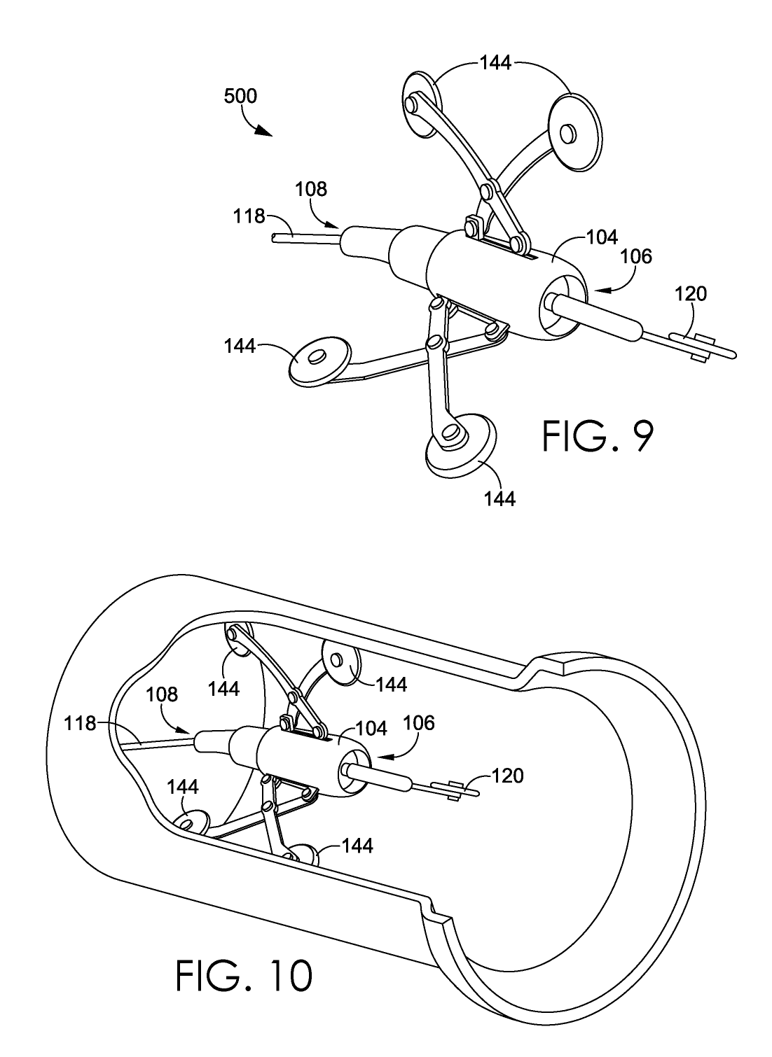

FIG. 9 depicts a pipe drone 500 with multiple bracing components 144 for securing the pipe drone 500 to the inner wall of a pipe, in accordance with an embodiment of the present technology. In FIG. 9, the pipe drone 500 includes a housing 104 having a first end 106, a second end 108, and a tether 118 coupled to the second end 108 of the housing 104. Coupled to the housing 104 are the bracing components 144 configured to brace the drone 500 against the inner wall of a pipe. A pipe repairing component 120 is affixed to the first end 106 of the pipe drone 500.

FIG. 10 depicts an exemplary use of the pipe drone 500 shown in FIG. 9, in accordance with an embodiment of the present technology. In FIG. 10, the pipe drone 500 is shown positioned inside a pipe, with the bracing components 144 coupled to the pipe drone 500 and extending from the housing 104 to the inner surface of the pipe wall at multiple locations. The bracing components 144 enable the pipe drone 500 to be securely positioned against the pipe wall so that the pipe repairing component 120 has sufficient leverage to operate against the inner surface of the pipe.

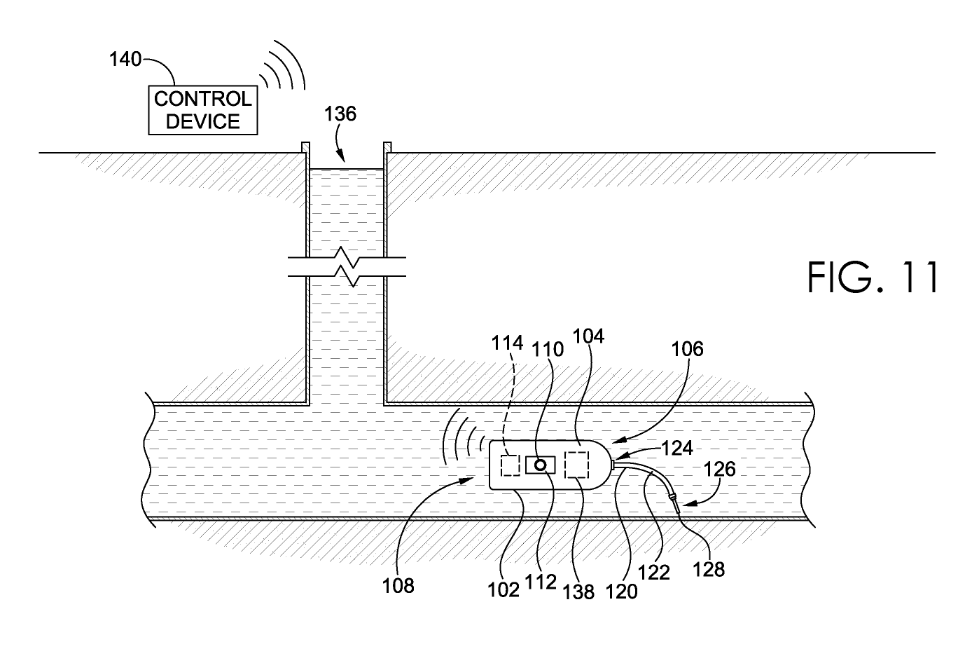

FIG. 11 depicts the pipe drone 102 controlled with a wireless control connection, in accordance with an embodiment of the present technology. In FIG. 11, the pipe drone 102 is shown traveling through a pipe system buried in the ground, with the entry point 136 for the pipe drone 102 being near the surface at an opening of the pipe system, such as a fire hydrant or a storm drain entrance, for example. The pipe drone 102 includes the housing 104, the leak detector 110 operating through the viewport 112, the pipe repairing component 120 having the elongated portion 122 with the first and second ends 124, 126 and the distal end nozzle 128, the propulsion device 114 coupled to the second end 108 of the housing 104 for propelling the drone 102 through the pipe system, and a communication component 138 wirelessly and communicatively connected to a control device 140.

The control device 140 is separate from the pipe drone 102 and is usable by an operator above ground. In this example, the control device 140 is configured to control the operation of the pipe drone 102 remotely, wirelessly, and from the surface, sending commands and instructions from the operator to the communication component 138 of the pipe drone 102. The commands and instructions may allow manual operation of leak detection and pipe repair by the pipe drone 102, or may provide for automated operation of the pipe drone 102 for the same.

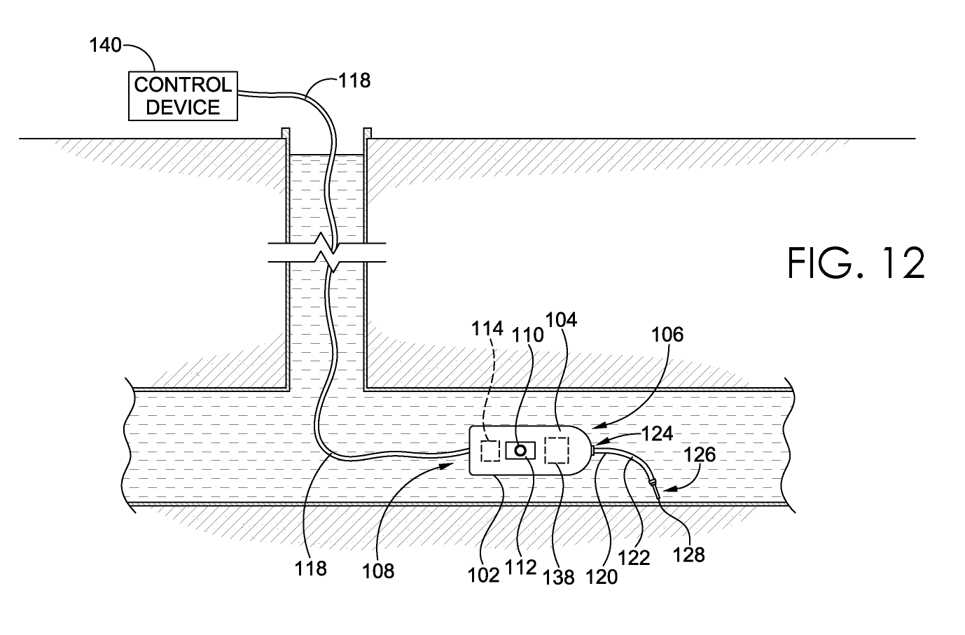

FIG. 12 depicts an exemplary use of the pipe drone 102 similar to FIG. 11, with the inclusion of a tethered control connection 118 between the control device 140 and the pipe drone 102, in accordance with an embodiment of the present technology. In FIG. 12, the tethered control connection 118 is configured to transmit power, instructions, and/or other forms of control to the pipe drone 102 or receive feedback from the pipe drone 102. Also, the tethered connection 118 may be used to retrieve the pipe drone 102, when necessary.

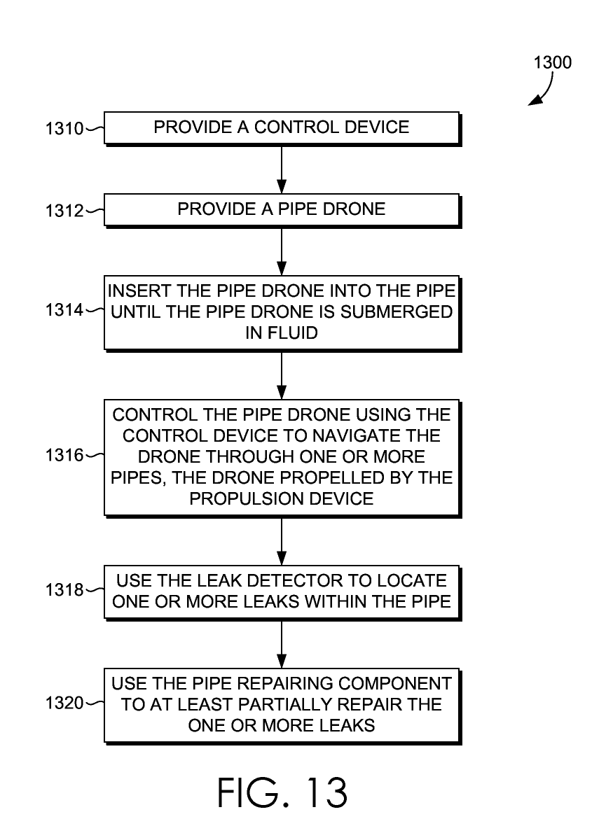

FIG. 13 depicts a block diagram of a method 1300 of detecting and repairing leaks inside pipes, in accordance with an embodiment of the present technology. At a block 1310, a control device, such as the control device 140 shown in FIG. 11, is provided. At a block 1312, a pipe drone, such as the pipe drone 102 shown in FIG. 1, is provided. The pipe drone may comprise a housing, such as the housing 104 shown in FIG. 1, a propulsion device, such as the propulsion device 114 shown in FIG. 1, a leak detector, such as the leak detector 110 shown in FIG. 1, a pipe repairing component, such as the pipe repairing component 120 shown in FIG. 1, and a communication component, such as the communication component 138 shown in FIG. 1, for example.

At a block 1314, the pipe drone is inserted into the pipe until the pipe drone is submerged in fluid. At a block 1316, the pipe drone is controlled using the control device to navigate the drone through one or more pipes, the drone propelled by the propulsion device. At a block 1318, the leak detector is used to locate one or more leaks within the pipe. At a block 1320, the pipe repairing component is used to at least partially repair the one or more leaks.

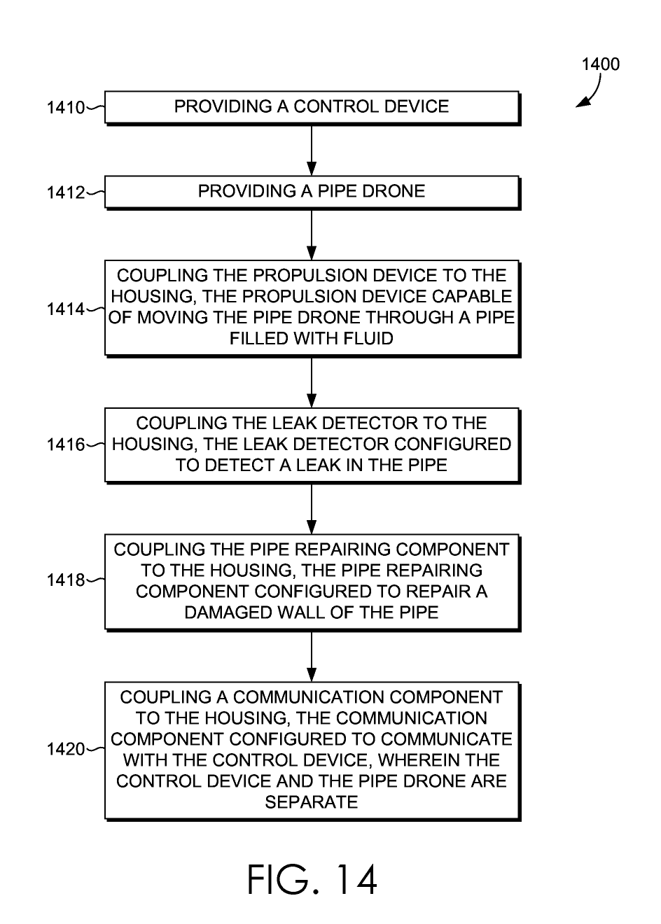

FIG. 14 depicts a block diagram of an exemplary method 1400 of manufacturing a device for detecting and repairing leaks inside pipes, in accordance with an embodiment of the present technology. At a block 1410, a control device, such as the control device 140 shown in FIG. 11, is provided. At a block 1412, a pipe drone, such as the pipe drone 102 shown in FIG. 1, is provided. The pipe drone may comprise a housing, such as the housing 104 shown in FIG. 1, a propulsion device, such as the propulsion device 114 shown in FIG. 1, a leak detector, such as the leak detector 110 shown in FIG. 1, a pipe repairing component, such as the pipe repairing component 120 shown in FIG. 1, and a communication component, such as the communication component 138 shown in FIG. 1, for example.

At a block 1414, the propulsion device is coupled to the housing, the propulsion device capable of moving the pipe drone through a pipe filled with fluid. At a block 1416, the leak detector is coupled to the housing, the leak detector configured to detect a leak in the pipe. At a block 1418, the pipe repairing component is coupled to the housing, the pipe repairing component configured to repair a damaged wall of the pipe. At a block 1420, the communication component is coupled to the housing, the communication component configured to communicate with the control device. The control device and the pipe drone are separate.

Embodiments of the technology have been described to be illustrative rather than restrictive. Alternative embodiments will become apparent to readers of this disclosure. Further, alternative means of implementing the aforementioned elements and steps can be used without departing from the scope of the claims below, as would be understood by one having ordinary skill in the art. Certain features and subcombinations are of utility and may be employed without reference to other features and subcombinations, and are contemplated as within the scope of the claims.

What is claimed is:

1. A system for detecting and repairing leaks inside pipes, the system comprising:
a control device; and
a pipe drone, comprising:
a housing,
a propulsion device coupled to the housing for moving the pipe drone through a pipe filled with fluid,
a leak detector,
a pipe repair component, and
a communication component providing communication between the control device and the pipe drone.

2. The system of claim 1, wherein the propulsion device includes a motor and a propeller.

3. The system of claim 1, wherein at least a portion of the pipe repair component extends from the housing to a distal end.

4. The system of claim 1, wherein the pipe drone and the control device are coupled by a tether.

5. The system of claim 4, wherein the control device is configured to provide power to the pipe drone through the tether.

6. The system of claim 1, wherein the pipe drone is self-powered.

7. The system of claim 1, wherein the communication component and the control device are configured for wireless communication.

8. The system of claim 1, wherein the leak detector is configured to detect a pipe leak using at least one of:
a pressure measurement;
a sensor measurement;
a radar measurement;
an infrared measurement; and
an acoustic measurement.

9. The system of claim 1, wherein the pipe repair component comprises at least one of:
a structural adhesive polymer;
a solvent cement;
a liquid epoxy;
a stent;
a patching element;
an expandable filler; and
a hyperbaric welding device.

10. The system of claim 1, wherein the communication component is configured to receive, from the control device, instructions for at least one of propulsion, leak detection, and pipe repair.

11. The system of claim 1, wherein the housing contains a viewport for the leak detector, and wherein the leak detector is contained within the housing.

12. The system of claim 1, wherein the propulsion device is configured to selectively move the pipe drone in a first forward direction and in a second backward direction.

13. The system of claim 1, further comprising a camera coupled to the pipe drone, the communication component configured to transmit images from the camera to the control device.

14. The system of claim 1, wherein the control device is configured to control at least one of the propulsion device, the leak detector, and the pipe repair component.

15. The system of claim 1, further comprising a drive mechanism coupled to the housing and configured to move the pipe drone through a pipe when the pipe drone is not fully submerged in fluid.

16. The system of claim 1, further comprising a bracing component coupled to the housing and configured to selectively secure the housing against an inner surface of the pipe.

17. A method of detecting and repairing leaks inside pipes, the method comprising:
providing a control device;
providing a pipe drone that is separate from the control device, the pipe drone comprising:
a housing,
a propulsion device coupled to the housing for moving the pipe drone through a pipe filled with fluid,
a leak detector,
a pipe repair component, and
a communication component configured to communicate with the control device;
inserting the pipe drone into the pipe filled with fluid;
navigating the pipe drone through one or more pipes using the control device;
using the leak detector to locate one or more leaks within the one or more pipes; and
using the pipe repair component to at least partially repair the one or more leaks.

18. The method of claim 17, wherein the control device and the communication component communicate using at least one of:
wireless communication; and
tethered communication.

19. The method of claim 18, further comprising sending instructions from the control device to the communication component to control at least one of the propulsion device, the leak detector, and the pipe repair component.

20. A method of manufacturing a device for detecting and repairing leaks inside pipes, the method comprising:
providing a control device;
providing a pipe drone comprising:
a housing,
a leak detector,
a pipe repair component,
a propulsion device, and
a communication component;
coupling the propulsion device to the housing, the propulsion device capable of moving the pipe drone through a pipe filled with fluid;
coupling the leak detector to the housing, the leak detector configured to detect a leak in the pipe;
coupling the pipe repair component to the housing, the pipe repair component configured to repair a damaged wall of the pipe; and
coupling the communication component to the housing so that the communication component and the control device are in communication.
